(19) United States
(12) Patent Application Publication
(10) Pub. No.: US 2012/0310741 A1
(43) Pub. Date: Dec. 6, 2012

(54) Advertisement Verification

(75) Inventors: Robert M. Uyeki, Torrance, CA (US); Go Yuasa, Rancho Palos Verdes, CA (US)

(73) Assignee: HONDA MOTOR CO., LTD., Tokyo (JP)

(21) Appl. No.: 13/152,458

(22) Filed: Jun. 3, 2011

(51) Int. Cl. G06Q 30/00

(52) U.S. Cl. 705/14.58; 705/14.64

(57) ABSTRACT

Methods, computing devices and systems may be provided for verifying and effectiveness of electronic coupons or electronic advertisements. A computing device, which may have navigation functions, may be located within a vehicle. The computing device may receive an electronic coupon or an electronic advertisement, which may be presented to a user via a display and may be sent to a nearby mobile device via a narrowband transmission. The computing device may determine whether a current location is proximate to a business associated with the presented electronic coupon or the electronic advertisement. The computing device may indicate to other computing devices within a system whether one or more separate or combined conditions are met with respect to the presented electronic coupon or the electronic advertisement. If the one or more conditions have been met, then a communication may be transmitted to a remote computing device executing an advertisement application.

### BACKGROUND

1. Field of the Invention

The present teachings relate to a method and a system for verifying and effectiveness of an electronic coupon or an electronic advertisement. In particular, the present teachings relate to a method and a system for verifying that an electronic coupon or an electronic advertisement is presented to a user and a likelihood that a user made a purchase at a business associated with the electronic coupon or the electronic advertisement.

2. Discussion of the Related Art

An electronic coupon is an electronic document that can be presented, when purchasing a product or a service, in order to receive a discount on a purchase price for the product or the service. An electronic advertisement is an electronic document, which advertises a product or a service. The electronic advertisement may be presented to a user via an electronic device.

Electronic coupons may be sent to users via the Internet. The users may print the electronic coupons, which may then be presented by the users in order to receive a discount when purchasing a product or a service. A new trend has developed in which electronic coupons are sent to a mobile phone or a personal data assistant (PDA). The trend is becoming popular and has a number of advantages, including no postage costs and no printing costs. Users may redeem the electronic coupons by presenting a displayed electronic coupon, on a mobile phone or a PDA, to a business when purchasing products or services.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In various embodiments, a computing device and a system may be provided. The computing device may be a navigation device in a vehicle or may be a handheld device. The handheld device may be a smart phone, a personal data assistant (PDA) or another type of handheld device with navigation functions. The computing device may receive an electronic coupon or an electronic advertisement, which may be presented to a user via a display of the computing device. The computing device may send an indication to remote computing device indicating that the electronic coupon or the electronic advertisement was viewed by a user of the computing device. Within a predefined time period after the computing device presents the electronic coupon or the electronic advertisement to the user, a merchant's system may send a second indication to the remote computing device indicating that a purchase was made at a business location associated with a presented electronic coupon or a presented electronic advertisement using a credit card or a debit card of the user.

In other embodiments, the computing device may receive an electronic coupon or an electronic advertisement and may present the electronic coupon or the electronic advertisement to a user via a display of the computing device. The computing device may then determine whether one or more conditions have been met, or satisfied, within a predetermined time period since the electronic coupon or electronic advertisement was presented to the user. If the one or more conditions have been met, the computing device may send a communication to a remote computing device indicating that the one or more conditions have been met within the predefined time period.

The one or more conditions may include, but not be limited to, the computing device being located within a proximity of a business associated with the presented electronic advertisement or the presented electronic coupon, the computing device being located within a specific area of the business associated with the presented electronic advertisement or the viewed electronic coupon based on an environment of the business, an ignition of a vehicle in which the computing device is located being turned off, an amount of time the computing device is located within a specific area before exiting the specific area, and whether a window or door of a vehicle is open while the computing device in the vehicle is located in the specific area.

### BRIEF DESCRIPTION OF THE DRAWINGS

In order to describe the manner in which the above-recited features and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIGS. 1 and 2 illustrate exemplary operating environments for various embodiments.

FIG. 3 is a functional block diagram of a computing device that may be used to implement various embodiments.

FIGS. 4-8 are flowcharts illustrating exemplary processing in a number of embodiments.

### DETAILED DESCRIPTION

### Overview

In various embodiments, an in-vehicle device may receive an electronic coupon or an electronic advertisement while a vehicle, including the in-vehicle device, is being driven to a store or a business. For example, while a user is driving a vehicle to a fast food restaurant, an in-vehicle device may receive an electronic coupon for the fast food restaurant. The in-vehicle device may present the fast food coupon to the user via a display. In some embodiments, the in-vehicle device may send a copy of the electronic coupon to a mobile device in the vehicle, including, but not limited to, a mobile phone or a personal data assistant (PDA). The user may carry the mobile device and present the electronic coupon to a business for redemption.

The in-vehicle device may have a short-range wireless connection with the mobile device and may send the copy of the electronic coupon to the mobile device via the short-range wireless connection. In various implementations, the short-range wireless connection may include, but not be limited to, a Bluetooth® connection (Bluetooth is a registered trademark of Bluetooth Sig, Inc. Corporation of Kirkland, Wash.).

Advertisers may wish to have information concerning an effectiveness of electronic coupons and/or electronic advertisements. In one embodiment, a computing device, including, but not limited to, a navigation unit within a vehicle, may receive an electronic coupon, which may further be sent to a mobile device within the vehicle. The computing device may present the electronic coupon to a user via a display and may send an indication, via a back channel, to a second computing device, which may be a verification computing device or other type of computing device. The indication may indicate that the electronic coupon was presented to the user. The user may redeem the electronic coupon at a business associated with the electronic coupon and may pay with a credit card or a debit card. A computing device of the business may transmit an indication of a card transaction of the user to the second computing device. Upon receiving the indication that the electronic coupon was presented to the user and the indication of the card transaction of the user at the business associated with the electronic coupon, the second computing device may send a communication to an advertisement verification application executing on the second computing device or a third computing device to indicate that the electronic coupon was likely redeemed.

In another embodiment, upon receiving an electronic coupon or an electronic advertisement, the computing device may determine whether one or more conditions are met within a predetermined time period. If the one or more conditions are determined to have been met within the predetermined time period, then the computing device may send a communication, to an advertisement verification application executing in a remote computing device, indicating that the electronic coupon or the advertisement was presented to a user and that the one or more conditions have been met.

The one or more conditions may include, but not be limited to: determining that a vehicle including the computing device is located in a specific area proximate to a location of a business associated with a presented electronic coupon or a presented electronic advertisement and a window or a door of the vehicle is opened; determining that the vehicle is located in the specific area and a cabin temperature of the vehicle is becoming closer to an outside temperature; determining that the vehicle is located in the specific area and an ignition of the vehicle is turned off; determining that the vehicle is located in the specific area and is exiting the specific area without having had the ignition turned off while in the specific area, and the vehicle was located within the specific area for at least a first predetermined time period and no more than a second predetermined time period.

### Exemplary Operating Environment

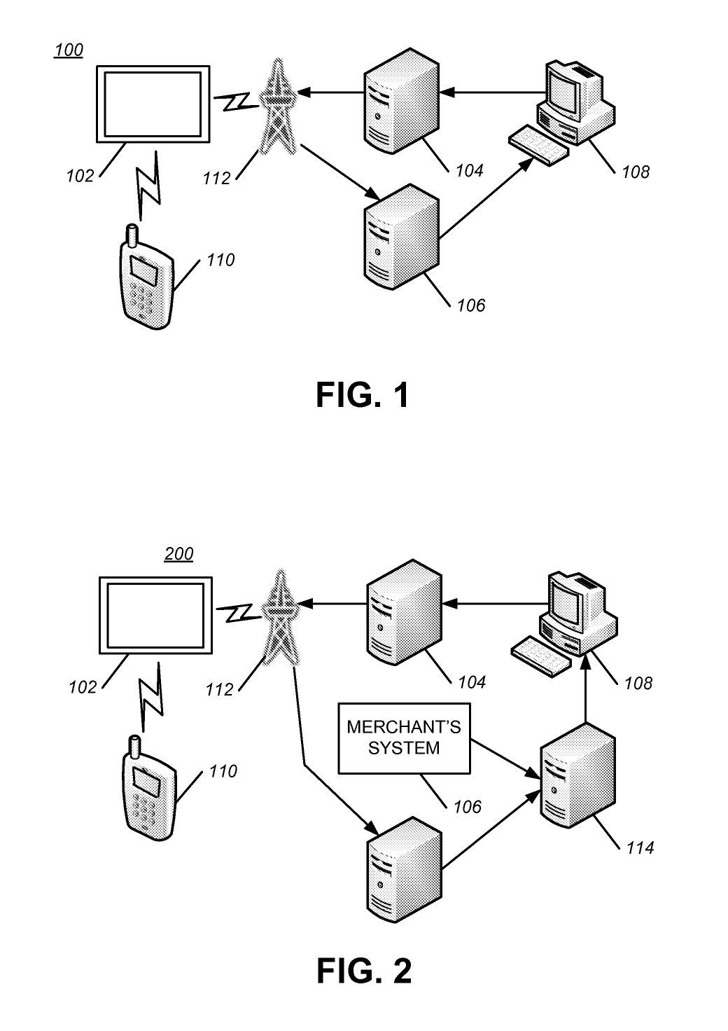

FIG. 1 illustrates an exemplary operating environment 100 for various embodiments. Operating environment 100 may include an in-vehicle device 102, a broadcast server 104, a back channel server 106, a computing device 108, a mobile device 110, and a wireless communication network 112.

In-vehicle device 102 may include a computing device, which may perform a number of functions, including, but not limited to, providing driving directions to a destination as a vehicle, including in-vehicle device 102, is being driven.

Broadcast server 104 may include a computing device or a number of computing devices operating as a server farm. Broadcast server 104 may communicate with in-vehicle device 102 via a wireless communication network 112. Wireless communication network 112 may be any network or combination of networks in which data may be transmitted wirelessly.

Back channel server 106 may receive communications from in-vehicle device 102 via wireless communication network 112.

Computing device 108 may be a single computing device or a group of networked computing devices executing an advertisement verification application. The advertisement verification application executing on computing device 108 may provide an advertisement or an electronic coupon to broadcast server 104 for transmission through wireless communication network 112 to in-vehicle device 102. In-vehicle device 102 may present the received advertisement or the received electronic coupon to a user via a display. In-vehicle device 112 may then determine whether the one or more predefined conditions have been satisfied. The one or more predefined conditions are discussed in more detail below.

After determining that one or more conditions have been satisfied, the in-vehicle device 102 may send one or more indications to back channel server 106 via wireless communication network 112. Back channel server 106 may then send a message including the one or more indications to computing device 108.

In some embodiments, in-vehicle device 102 may transmit the electronic coupon to mobile device 110, such that the user may present the electronic coupon to a merchant or service provider via mobile device 110.

FIG. 2 illustrates a second exemplary operating environment 200 for various embodiments. Operating environment 200 may be similar to operating environment 100, but may further include a verification computing device 214 and a merchant's system 216.

Verification computing device 214 may be a computing device or a network of computing devices working together. In one embodiment, verification computing device may include a server or a server farm.

Merchant's system 216 may include one or more computing devices for recording transactions, such as, for example, credit card transactions or debit card transactions at a merchant's business.

In operating environment 200, an advertisement verification application executing on computing device 108 may transmit an electronic advertisement or an electronic coupon to broadcast server 104. Broadcast server 104 may send the electronic advertisement or the electronic coupon to in-vehicle device 102 via wireless communication network 112. In-vehicle device 102 may present the electronic coupon or the electronic advertisement to a user and may send an indication to back channel server 106 via wireless communication network 112. The indication indicates that the electronic coupon or the electronic advertisement was presented to the user via a display of in-vehicle device 102.

Back channel 106 server may receive the indication from in-vehicle device 102 and may transmit the indication to verification computing device 214 via one or more networks. Verification computing device 214 may receive the indication from in-vehicle device 102 and may wait to receive an indication from merchant's system 216 regarding a credit card transaction or a debit card transaction with respect to the user making a purchase at a location of a business associated with the presented electronic advertisement or the electronic coupon. After receiving the indication from in-vehicle device 102 and the indication from merchant's system 216, verification computing device 214 may send a communication to computing device 108 informing computing device 108 that the user made a purchase at the location of the business associated with the electronic coupon or the electronic advertisement.

### Exemplary Computing Device

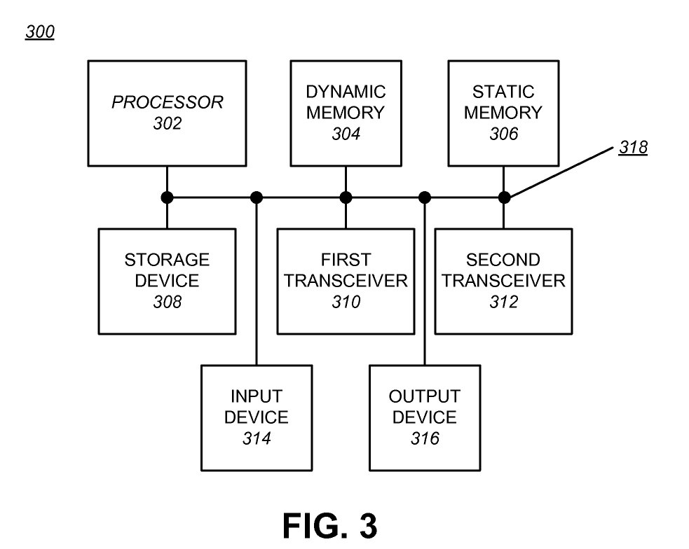

FIG. 3 is a functional block diagram which illustrates an exemplary in-vehicle device 102, which may be included in various embodiments. In-vehicle device 102 may include a bus 318, a processor 302, dynamic memory 304, static memory 306, storage device 308, first transceiver 310, second transceiver 312, input device 314 and an output device 316. Bus 105 may permit communication between processor 120 and components of computing device 100.

Bus 318 may connect processor 302 with dynamic memory 304, static memory 306, storage device 308, first transceiver 310, second transceiver 312, input device 314 and output device 316.

Processor 302 may include at least one conventional processor or microprocessor that interprets and executes instructions. Dynamic memory 304 may include a random access memory (RAM) or another type of dynamic storage device that stores information and instructions for execution by processor 302. Dynamic memory 304 may also store temporary variables or other intermediate information used during execution of instructions by processor 302. Static memory 306 may include a conventional ROM device or another type of static storage device that stores static information and instructions for processor 120. Dynamic memory 304 and static memory 306 are examples of machine-readable storage media. Machine-readable storage media do not include communication media, such as, for example, a modulated carrier wave, or signal, having information encoded therein.

Input device 314 may include one or more conventional mechanisms that permit a user to input information to computing device 300, such as, for example, a keyboard, a touchscreen, a microphone, or other input device. Output device 316 may include a speaker, a display screen, or other output device for providing output to a user.

First transceiver 310 may include any transceiver-like mechanism that enables computing device 300 to communicate with other devices via a narrow-band communication medium. In one embodiment, first transceiver 310 may communicate via the Bluetooth® protocol (Bluetooth is a registered trademark of Bluetooth Sig, Inc. Corporation of Kirkland Wash.). Second transceiver 312 may include a transceiver-like mechanism that enables computing device 300 to communicate over a wireless network, through which computing device 300 may communicate with other devices.

Computing device 300 may perform such functions in response to processor 302 executing sequences of instructions contained in a computer-readable storage medium, such as, for example, ROM, RAM, or other storage medium capable of storing instructions and data with some degree of permanence.

One or more of computing device 300 may also be used as broadcast server 104, back channel server 106, verification computing device 114, computing device 108 or merchant's system 116. When computing device 300 is used as any of broadcast server 104, back channel server 106, verification computing device 114, computing device 108 or merchant's system 116, computing device 300 may include only one transceiver, including, but not limited to, second transceiver 312 or a different transceiver.

### Exemplary Processing

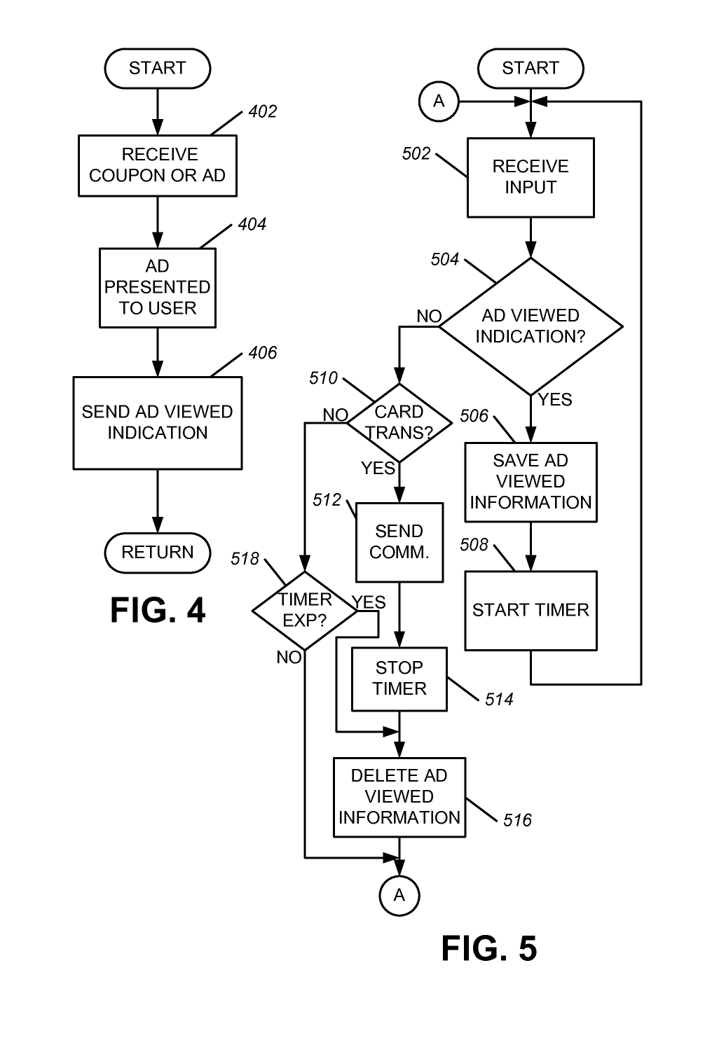

FIGS. 4 and 5 are flowcharts illustrating exemplary processing in an embodiment operating in exemplary operating environment 200. The process may begin with in-vehicle device 102 receiving an electronic coupon or an electronic advertisement (act 402; FIG. 4). The electronic coupon or the electronic advertisement may have originated from an advertisement verification application executing on computing device 108. The electronic coupon or the electronic advertisement may be transmitted from computing device 108 via one or more networks to broadcast server 104. Broadcast server 104 may then forward the electronic coupon or the electronic advertisement to in-vehicle device 102 via wireless communication network 112.

After receiving the electronic coupon or the electronic advertisement, in-vehicle device 102 may present the electronic coupon or the electronic advertisement to a user (act 404). In some embodiments, in-vehicle device 102 may present the electronic coupon or the electronic advertisement via a display of in-vehicle device 102. After presenting the electronic coupon or the electronic advertisement, in-vehicle device 102 may send an indication to back channel server 106 via a wireless communication network 112 (act 406).

Verification computing device 114 (FIG. 2) may receive input from back channel 106 or from merchant's system 116 via the one or more networks (act 502; FIG. 5). Verification computing device 114 may then determine whether the received input is an indication regarding a presenting of the electronic coupon or the electronic advertisement from in-vehicle device 102 (act 504).

If, during act 504, verification computing device 114 determines that the received input is the indication that the electronic coupon or the electronic advertisement was presented by in-vehicle device 102, then verification computing device 114 may save information with respect to the electronic coupon or the electronic advertisement (act 506). Verification computing device 114 may then start a timer for a predetermined time period (act 508) and may again wait to receive an input (act 502).

If, during act 504, verification computing device 114 determines that the received input is not the indication that the electronic advertisement or the electronic coupon was presented, then verification computing device 114 may determine whether the input is an indication that a credit card or a debit card of a user associated with in-vehicle device 102 has been used at a location of a business associated with the electronic coupon or the electronic advertisement (act 510).

If, during act 510, verification computing device 114 determines that the received input is the indication that the credit card or the debit card of the user has been used at a location of the business associated with the electronic coupon or the electronic advertisement, then verification computing device 114 may send a communication to an advertisement verification application executing on computing device 108 to inform the advertisement verification application that one or more predetermined conditions have been met (in this example, the conditions include the viewing of the electronic coupon or the electronic advertisement via in-vehicle device 102 and a purchase being made at a location of a business associated with the electronic coupon or the electronic advertisement with a credit card or a debit card of the user associated with the in-vehicle device 102.

Verification computing device 114 may then stop the timer (act 514) and may delete the information with respect to the electronic coupon or the electronic advertisement (act 516). Verification computing device 114 may then prepare to receive an input (act 502).

If, during act 510, verification computing device 114 determines that the received input is not the indication that a purchase was made at the location of the business associated with the electronic coupon or the electronic advertisement with the credit card or the debit card of the user associated with the in-vehicle device 102, then verification computing device 102 may discard the communication or perform other processing, after which verification computing device 108 may again wait to receive an input (act 502).

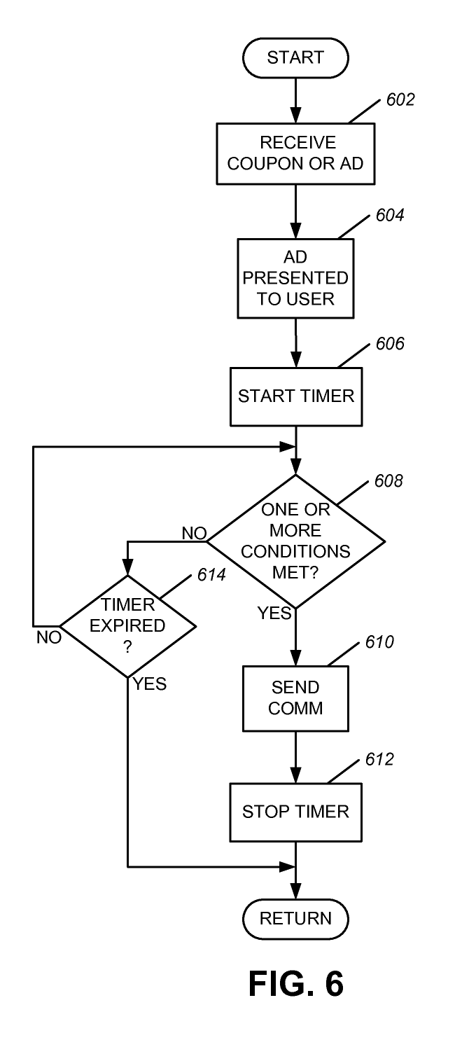

FIG. 6 is a flowchart that illustrates exemplary processing with respect to in-vehicle device 102 in exemplary operating environment 100. The process may begin with in-vehicle device 102 receiving an electronic coupon or electronic advertisement (act 602). The received electronic coupon or electronic advertisement may be presented to a user via a display of in-vehicle device 102 (act 604). Alternatively, in-vehicle device 102 may send the electronic coupon or the electronic advertisement to mobile device 110 for presentation to the user. In-vehicle device 102 may then start a timer for a predetermined time period (act 606). The predetermined time period may be defined to be one day, one week, or another suitable time period.

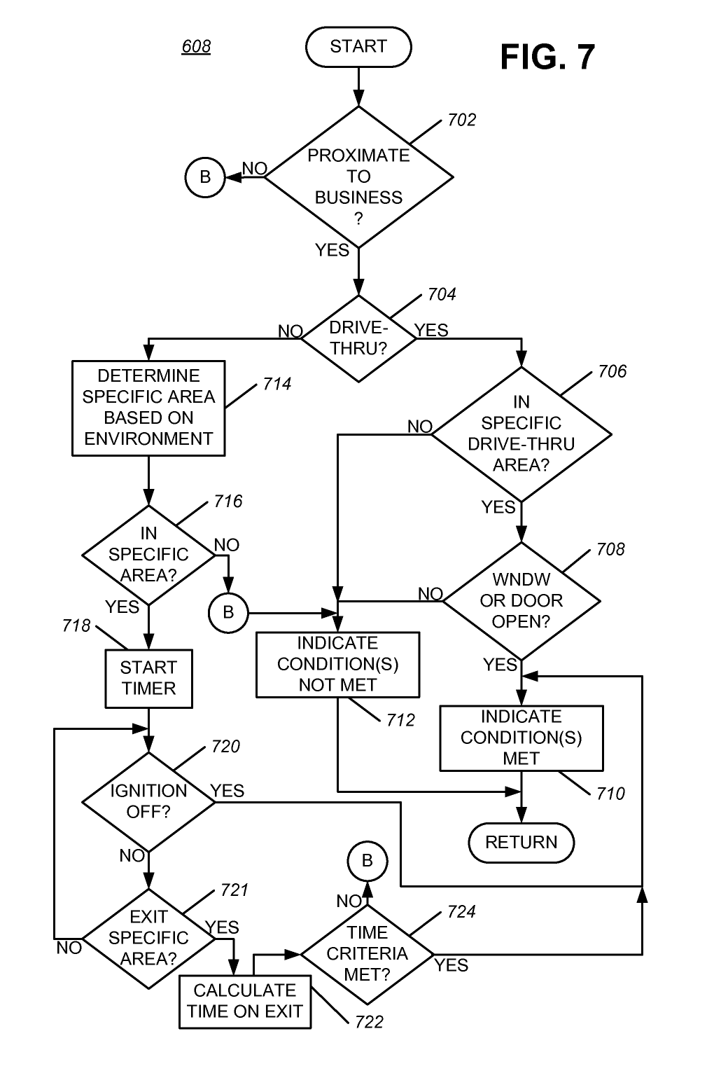

In-vehicle device 102 may then determine whether one or more predefined conditions are satisfied (act 608). FIG. 7 is a flowchart illustrating exemplary processing with respect to act 608. The process may begin with in-vehicle device 102 determining whether a location of a vehicle, including in-vehicle device 102, is proximate to a location of a business associated with the presented electronic advertisement or the electronic coupon (act 702).

If in-vehicle device 102 determines that the vehicle including in-vehicle device 102 is located proximate to the business associated with the present electronic advertisement or the electronic coupon, then in-vehicle device 102 may determine whether the business is a drive-through business (act 704). If, during act 704, in-vehicle device 102 determines that the business is a drive-through business, then in-vehicle device 102 may determine whether the vehicle including the in-vehicle device 102 is located within a specific drive-through area, including, but not limited to, a location next to a drive-through window (act 706).

If, during act 706, in-vehicle device 102, determines that the vehicle including in-vehicle device 102 is located within the specific drive-through area, then in-vehicle device 102 may determine whether a window or a door of the vehicle is open (act 708).

In one embodiment, the vehicle may include a window sensor for determining that the window of the vehicle is open and a door sensor for determining that the door of the vehicle is open. A signal from the window sensor or the door sensor may be provided to in-vehicle device 102 to indicate that the window or the door is open.

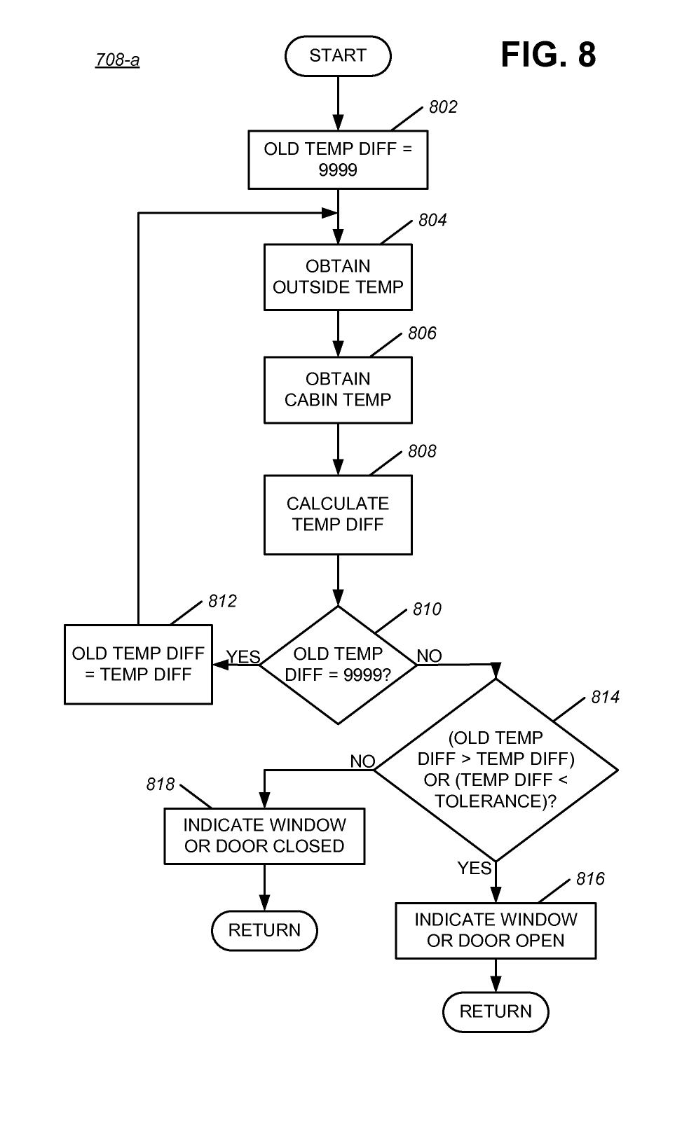

In another embodiment, the vehicle may not have a window sensor and a door sensor. In such a case, FIG. 8 illustrates exemplary processing for determining whether the window or the door of the vehicle is open. The process may begin by setting a variable, old_temp_diff, to a maximum value, such as, for example, 9999 or another value (act 802). In-vehicle device 102 may then obtain an outside temperature via an outside temperature sensor (act 804). Next, in-vehicle device 102 may obtain a cabin temperature of the vehicle via a cabin temperature sensor (act 806). In-vehicle device 102 may then calculate a temperature difference between the outside temperature and the cabin temperature (act 808).

In-vehicle device 102 may then determine whether the variable, old_temp_diff, is equal to the maximum value, indicating that another set of temperature readings are to be obtained before comparing temperature readings (act 810). If in-vehicle device 102 determines that the variable, old_temp_diff, is equal to the maximum value, then in-vehicle device 102 may set the variable, old_temp_diff, equal to the calculated temperature difference, temp_diff (act 812). In-vehicle device 102 may then repeat acts 804-810.

If, during act 810, in-vehicle device 102 determines that the variable, old_temp_diff does not equal the maximum value, then in-vehicle device 102 may determine whether a difference between the outside temperature and the cabin temperature is getting smaller or whether the current temperature difference is within a predefined tolerance (act 814). The predefined tolerance may be 5 degrees or another value. If in-vehicle device 102 determines that the difference between the outside temperature and the cabin temperature is getting smaller or that the current temperature difference is within the predefined tolerance, then in-vehicle device 102 may determine that the window or the door of the vehicle is open (act 816). Otherwise, in-vehicle device 102 may determine that the window or the door of the vehicle is closed (act 818).

Returning to act 708 of FIG. 7, if in-vehicle device 102 determines that the window or the door is open, then in-vehicle device 102 may indicate that the conditions are met, or satisfied (act 710). Otherwise, in-vehicle device 102 may indicate that the conditions are not met, or satisfied (act 712).

If, during act 706, in-vehicle device 102 determines that the vehicle including in-vehicle device 102 is not located in the specific drive-through area, then in-vehicle device 102 may indicate that the conditions are not met, or satisfied (act 712).

If, during act 704, in-vehicle device 102 determines that the business is not a drive-through business, then in-vehicle device 102 may determine a specific area in a location proximate to the business (act 714). In-vehicle device 102 may then determine whether the vehicle including in-vehicle device 102 is located in the specific area (act 716). If the vehicle including in-vehicle device 102 is not located in the specific area, then in-vehicle device 102 may indicate that the conditions are not met, or satisfied (act 712). Otherwise, in-vehicle device 102 may start a timer (act 718).

In-vehicle device 102 may then determine whether an ignition of the vehicle is turned off while the vehicle is located in the specific area (act 720). If in-vehicle device 102 determines that the ignition is turned off while the vehicle is located in the specific area, then in-vehicle device 102 may indicate that the conditions are met, or satisfied (act 710). Otherwise, in-vehicle device 102 may determine whether the vehicle is exiting the specific area (act 721).

If, in-vehicle device 102 determines that the vehicle is not exiting the specific area, then in-vehicle device 102 may repeat acts 702. Otherwise, in-vehicle device may calculate an amount of time the vehicle was located in the specific area based on the timer started during act 716 (act 722).

Next, in-vehicle device 102 may determine whether a predefined time criteria is met (act 724). In one embodiment, the predefined time criteria may be defined as being satisfied when the calculated amount of time the vehicle was located in the specific area is determined to be more than five minutes. In other embodiments, the predefined time criteria may be satisfied when the calculated amount of time the vehicle was located in the specific area is determined to be greater than a first amount of time and less than a second amount of time. In some embodiments, the first amount of time may be 5 minutes and the second amount of time may be 15 minutes. Although other amounts of time may be used in other embodiments.

If the in-vehicle device 102 determines that the time criteria is met, then in-vehicle device may indicate that the conditions are met (act 710). Otherwise, in-vehicle device 102 may indicate that the conditions are not met (act 712).

If, during act 702, in-vehicle device 102 determines that the vehicle is not located proximate to the business, then in-vehicle device 102 may indicate that the conditions are not met (act 712).

Returning to act 608 of FIG. 6, if in-vehicle device determines that the one or more conditions are met, then in-vehicle device 102 may send a communication, indicating that the conditions are met, to an advertisement verification application executing on computing device 108 via wireless communication network 112, back channel server 106, and one or more networks to computing device 108 (act 610). In-vehicle device 102 may then stop the timer that was started during act 606.

If, during act 608, in-vehicle device 102 determines that the one or more conditions are not met, then in-vehicle device 102 may determine whether the timer started during act 606 expired (act 614). If in-vehicle device 102 determines that the timer did not expire then act 608 may be repeated. Otherwise, the process may be completed.

### Miscellaneous

Although the above-discussed embodiments disclosed various components, such as in-vehicle device 102, advertisement verification application implemented in computing device 108, and verification computing device 114 having certain functions. In other embodiments, the functions may be performed in other components.

For example, in one embodiment, in-vehicle device 102 may send an indication to computing device 108 regarding each of the one or more conditions that are met. Computing device 108 may determine whether certain predefined combinations of conditions are met and, if so, may record information to that effect for a report to be produced later.

In another embodiment, in-vehicle device 102 may transmit an indication to verification computing device 114 with respect to each of the one or more conditions that are met. Verification computing device 114 may determine whether certain predefined combinations of conditions are met with respect to an electronic advertisement or an electronic coupon, and if the predefined combinations of conditions are determined to be met, verification computing device 114 may send a communication to computing device 108 to inform the advertisement verification application about the one or more conditions being met with respect to the electronic coupon or the electronic advertisement.

Further, the above-discussed embodiments described functions of an in-vehicle device. However, in-vehicle device may be a computing device and, in some embodiments, may be a handheld computing device, including, but not limited to, a smart phone, a PDA, or a handheld navigation device. In such embodiments, the handheld computing device may determine a location of itself rather than a location of a vehicle.

### Conclusion

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they are not to be construed as limiting the claims in any way. Other configurations of the described embodiments are part of the scope of this disclosure. Accordingly, the appended claims and their legal equivalents define the invention, rather than any specific examples given.

We claim as our invention:

1. An advertisement verification method comprising:
receiving, by a computing device, an electronic coupon;
presenting, by the computing device, the electronic coupon to a user;
determining, by at least one of a plurality of computing devices including the computing device, whether one or more conditions related to the presented electronic coupon are met, the one or more conditions consisting of:
a vehicle including the computing device being located proximate to a business, associated with the electronic coupon,
sensing an ignition of the vehicle being turned off,
sensing a window of the vehicle or a door of the vehicle being opened, and
determining that an interior temperature of the vehicle is approaching an outside temperature; and
sending, by the computing device, a communication indicating that the one or more conditions related to the presented electronic coupon are met.

2. The advertisement verification method of claim 1, further comprising:
transmitting the electronic coupon from the computing device to a mobile device;

3. The advertisement verification method of claim 1, further comprising:
sending, by the computing device, an indication that the electronic coupon was viewed.

4. The advertisement verification method of claim 1, further comprising:
determining, by the computing device, that an ignition of the vehicle is turned off while the vehicle is located within the specific area proximate to the location of business, wherein:
the communication further indicates that the ignition of the vehicle is turned off while the vehicle is located within the specific area proximate to the location of business.

5. The advertisement verification method of claim 4, wherein:
the determining that an ignition of the vehicle is turned off while the vehicle is located within the specific are proximate to the location of business further comprises:
determining, by the in-vehicle apparatus, that the ignition is turned off for at least a predetermined period of time, and
the sending a communication indicating that the one or more conditions related to the presented electronic coupon are met is performed when the computing device determines that the ignition is turned off for at least the predetermined period of time.

6. The advertisement verification method of claim 1, further comprising:
determining, by the computing device, an amount of time the vehicle is located within a specific area proximate to a location of the business when the business is a drive-thru business;
determining, by the in-vehicle apparatus, that a window of the vehicle or a door of the vehicle is in an open position while the vehicle is determined to be located within the specific area proximate to the location of the business; and
sending, by the computing device, the communication indicating that the one or more conditions related to the presented electronic coupon are met when the amount of time the vehicle is determined to be located within the specific area is greater than a first predetermined amount and less than a second predetermined amount, and the window of the vehicle or the door of the vehicle is determined to be in an open position while the vehicle is determined to be located within the specific area proximate to the location of the business.

7. The advertisement verification method of claim 6, wherein the sending a communication indicating that the one or more conditions related to the presented electronic coupon are met further comprises:
performing when the vehicle has either a door sensor or a window sensor:
determining whether one of the window or the door is open while the vehicle is located within the specific area, and
sending the communication when the one of the window or the door is determined to be open while the vehicle is located within the specific area;
performing when the vehicle has at least two temperature sensors:
comparing a cabin temperature of the vehicle with an outside temperature, and
sending the communication when a difference between the cabin temperature and the outside temperature becomes smaller while the vehicle is located within the specific area.

8. A first computing device comprising:
at least one processor and a memory connected to the at least one processor, the memory having instructions stored therein for the at least one processor such that, when the instructions are executed by the at least one processor, the first computing device performs a method comprising:
receiving an electronic coupon or an advertisement;
presenting the electronic coupon or the advertisement to a user;
determining whether the first computing device is located within a specific area proximate to a location of a business associated with the electronic coupon or the advertisement after the electronic coupon or the advertisement is presented to the user; and
sending a communication indicating that one or more conditions related to the presented electronic coupon are met when the first computing device determines that the first computing device is located within a specific area proximate to a location of a business associated with the electronic coupon or the advertisement after the electronic coupon or the advertisement is presented to the user.

9. The first computing device of claim 8, wherein the first computing device is a handheld computing device.

10. The first computing device of claim 8, wherein:
the first computing device is an in-vehicle device; and
the method further comprises:
sending the electronic coupon or the advertisement to a handheld computing device.

11. The first computing device of claim 8, wherein the method further comprises:
determining that an ignition of a vehicle, in which the first computing device is located, is turned off while the vehicle is located within the specific area proximate to the business; and
sending the communication when the determining determines that the ignition of the vehicle is turned off while the vehicle is located within the specific area proximate to the business.

12. The first computing device of claim 8, wherein the method further comprises:
determining that an ignition of a vehicle, in which the first computing device is located, is turned off for at least a predetermined period of time while the vehicle is located within the specific area proximate to the business; and
sending the communication when the determining determines that the ignition of the vehicle is turned off for at least the predetermined period of time while the vehicle is located within the specific area proximate to the business.

13. The first computing device of claim 8, wherein the method further comprises:
determining an amount of time the vehicle is located within the specific area proximate to the business when the business is a drive-thru business;
determining whether a window of the vehicle or a door of the vehicle is in an open position while the vehicle is determined to be located within the specific area proximate to the business; and
sending the communication when the amount of time the vehicle is determined to be located within the specific area is greater than a first predetermined amount and the window of the vehicle or the door of the vehicle is determined to be in an open position while the vehicle is determined to be located within the specific area proximate to the business.

14. The first computing device of claim 8, wherein the method further comprises:
determining whether, with respect to a vehicle in which the first computing device is located, one of a window or a door is opened while the vehicle is located within the specific area, and
sending the communication when the one of the window or the door is determined to be open while the vehicle is located within the specific area.

15. The first computing device of claim 8, wherein the method further comprises:
comparing a cabin temperature of a vehicle, in which the first computing device is located, with an outside temperature, and
sending the communication when a difference between the cabin temperature and the outside temperature becomes smaller while the vehicle is determined to be located within the specific area.

16. The first computing device of claim 8, wherein the method comprises:
transmitting the electronic coupon from the first computing device to a handheld mobile device.

17. A machine-readable storage medium having instructions recorded thereon for at least one processor of a computing device to perform a method, the method comprising:
receiving a first indication indicating that an electronic coupon was presented to a user;
receiving a second indication indicating that a credit card of the user or a debit card of the user was used to make a purchase at a business associated with the electronic coupon or the advertisement after receiving the indication that the electronic coupon or the advertisement was presented to the user; and
sending a communication indicating that the user made a purchase at the business in response to receiving the first indication and the second indication.

18. The machine-readable storage medium of claim 17, wherein the sending a communication is performed only when the first indication and the second indication are received within a predetermined amount of time of each other.

19. The machine-readable storage medium of claim 17, wherein the method further comprises:
receiving a third indication indicating that a vehicle of the user is located proximate to a location of the business for at least a predetermined amount of time, wherein:
the sending a communication indicating that the user made a purchase at the business is in response to receiving all of the first indication, the second indication, and the third indication.

20. The machine-readable storage medium of claim 17, wherein the method further comprises:
receiving a third indication indicating that an ignition of the vehicle is turned off while the vehicle is located proximate to a location of the business, wherein:
the sending a communication indicating that the user made a purchase at the business is in response to receiving all of the first indication, the second indication, and the third indication.

21. The machine-readable storage medium of claim 20, wherein the third indication indicates that the ignition of the vehicle is turned off for at least a predetermined amount of time.

22. The machine-readable storage device of claim 17, wherein the method further comprises:
receiving one or more third indications indicating that a vehicle of the user is located within a specific area proximate to a location of the business for at least a predetermined amount of time and that either a window of a vehicle or a door of the vehicle is in an open position while the vehicle is located within the specific area; and
the sending a communication indicating that the user made a purchase at the business is in response to receiving all of the first indication, the second indication, and the one or more third indications.
